(19) United States
(12) Patent Application Publication
(10) Pub. No.: US 2013/0317976 A1
(43) Pub. Date: Nov. 28, 2013

(54) Proxy Shopper Payments

(71) Applicants: Byong Mok Oh, San Jose, CA (US); German Carlos Scipioni, San Jose, CA (US)

(72) Inventors: Byong Mok Oh, San Jose, CA (US); German Carlos Scipioni, San Jose, CA (US)

(73) Assignee: EBAY, INC., San Jose, CA (US)

(21) Appl. No.: 13/481,070

(22) Filed: May 25, 2012

(51) Int. Cl. G06Q 20/40

(52) U.S. Cl. 705/39

(57) ABSTRACT

Methods and systems are provided for facilitating payment by one person for products purchased by another person. For example, payment can be authorized, such a by a payment provider, when the purchaser is authorized to make the purchase, the product purchased is authorized for purchase, and the store at which the product was purchased is authorized for such purchasing by the other person.

### BACKGROUND

1. Technical Field

The present disclosure generally relates to electronic commerce and, more particularly, relates to a method and system for facilitating payment by one person for products purchased by another person.

2. Related Art

The use of cards to make purchases is well known. Such cards can include credit cards, debit cards, gift cards, and the like. Cards can be used to purchase products from brick and mortar stores as well as to purchase products from merchants online. For example, a card holder can visit a brick and mortar store, select products to be purchased, go through a merchant checkout counter to use the card to complete the purchase, and return home with the purchased times. As a further example, the card holder can visit an online store via the Internet, purchase products using the card, and have the products delivered to the card holder's home. Delivery of the products to the card holder's home can usually be done within a few days. In either instance, a bank or payment provider, such as PayPal, Inc. can facilitate payment from an account of the card holder to an account of the merchant.

Typically, the card holder personally makes such purchases. That is, card holders most often shop for themselves. This is generally true whether the purchase is made at a brick and mortar store or is made online. However, it is often desirable to have another person make a purchase on behalf of the card holder. The card holder may be unable to shop personally or may find it inconvenient to do so.

To facilitate such purchases by another person, the card holder may provide the other person with the card holder's card or card number. However, providing another person with a card or card number can undesirably facilitate card fraud. The other person can make unauthorized purchases with the card. Thus, it is desirable to facilitate purchasing by others on behalf of a cardholder while also mitigating the likelihood of fraud.

### SUMMARY

Methods and systems are provided for facilitating payment by one person for products purchased by another person. The person for whom the products are purchased can be referred to herein as a user. The person making the purchases can be referred to herein has a proxy shopper. Thus, the proxy shopper can be a person who is authorized by the user to make purchases on behalf of the user.

According to an embodiment, an adaptive payment system can have a memory and a processor. The memory can store account information for the user and the proxy shopper. The account information can include an identification of one or more proxy shoppers, products authorized for purchase by the proxy shoppers, and stores authorized for use by the proxy shoppers. The processor can receive a communication including an indication of a product purchased by a purchaser at a store, access the account information in the user account, determine from the information if the purchaser is a proxy shopper of the user, determine from the information if the product is a product authorized for purchase by the proxy shopper, and determine from the information if the store is a store authorized for use by the proxy shopper. The processor can authorize payment from the user account to a proxy shopper account if the purchaser is a proxy shopper of the user, the product is a product authorized for purchase by the proxy shopper, and the store is a store authorized for use by the proxy shopper. If the purchaser is a not proxy shopper of the user, the product is not a product authorized for purchase by the proxy shopper, or the store is not a store authorized for use by the proxy shopper, then the processor can not authorize a payment from the user account. If the purchaser is a proxy shopper of the user, but the product is not a product authorized for purchase by the proxy shopper or the store is not a store authorized for use by the proxy shopper, then the processor can optionally notify the user and ask the user if the processor can authorize a payment from the user account.

According to an embodiment, a method can comprise storing, in a memory, account information for the user. The account information can include an identification of the proxy shopper, products authorized for purchase by the proxy shopper, and stores (either brick and mortar stores or online stores) authorized for use by the proxy shopper. The method can further comprise receiving a communication including an indication of a product purchased by a purchaser at a store, accessing the account information in the user account, determining from the information if the purchaser is a proxy shopper of the user, determining from the information if the product is a product authorized for purchase by the proxy shopper, and determining from the information if the store is a store authorized for use by the proxy shopper. Payment can be authorized from the user account to the proxy shopper account if the purchaser is a proxy shopper of the user, the product is a product authorized for purchase by the proxy shopper, and the store is a store authorized for use by the proxy shopper.

According to an embodiment, a computer program product can comprise a non-transitory computer readable medium having computer readable and executable code for instructing a processor to perform a method. The method can comprise storing, in a memory, account information for the user. The account information can include an identification of the proxy shopper, products authorized for purchase by the proxy shopper, and stores authorized for use by the proxy shopper. The method can further comprise receiving a communication including an indication of a product purchased by a purchaser at a store, accessing the account information of the user account, determining from the information if the purchaser is a proxy shopper of the user, determining from the information if the product is a product authorized for purchase by the proxy shopper, and determining from the information if the store is a store authorized for use by the proxy shopper. Payment can be authorized from an account of the user to the proxy shopper account if the purchaser is a proxy shopper of the user, the product is a product authorized for purchase by the proxy shopper, and the store is a store authorized for use by the proxy shopper.

According to an embodiment, the proxy shopper can be reimbursed by the user for the purchase. According to an embodiment, the user can pay directly for the purchase.

### BRIEF DESCRIPTION OF THE DRAWINGS

FIG. 1 is a block diagram showing a system for making adaptive payments, according to an embodiment;

FIG. 2 is a flow chart showing a method for making adaptive payments, according to an embodiment;

FIG. 3 is a flow chart showing further detail for the method for making adaptive payments, according to an embodiment; and

FIG. 4 is a block diagram of a computer system suitable for implementing one or more components in FIG. 1, according to an embodiment.

### DETAILED DESCRIPTION

According to one or more embodiments of the present invention, methods and systems are provided for facilitating payment by one person, e.g., a user, for products purchased by another person, e.g., a proxy shopper. The payment can be via a credit card of the proxy shopper. The products can be any items or anything else that can be purchased. The products purchased can be for use by the user, for use by the proxy shopper, or for use by anyone else. The user can be automatically charged for the purchased products. For example, a proxy shopper account can be automatically credited with money, such as from a user account.

The proxy shopper account can be a payment provider account, a card account (such as a credit card account, a debit card account, or a gift card account), or any other type of account that can facilitate a purchase by the proxy shopper on behalf of the user. The user account can be a payment provider account, a card account, a bank account, or any other type of account that can be used, either directly or indirectly, to pay for the purchase. The user account can be used to reimburse the proxy shopper after the proxy shopper makes the purchase using the proxy shopper account. The user account can be used to pay for the purchase without the proxy shopper account being charged.

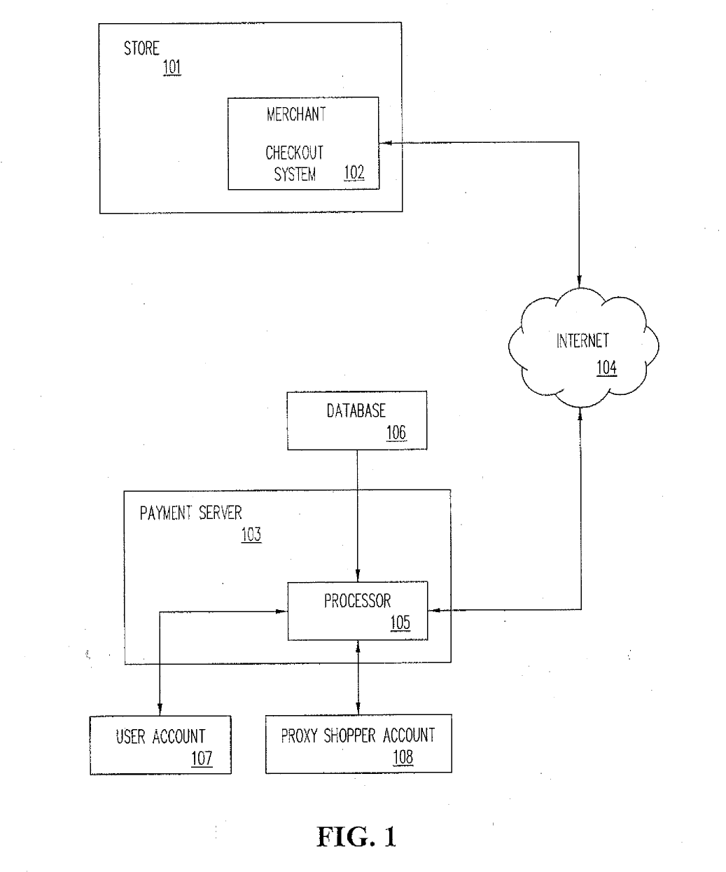

FIG. 1 is a block diagram showing a system for making adaptive payments, according to an embodiment. The system can include a store 101 having a merchant checkout system 102. The store can be a brick and mortar store, an online store, or any other type of store. A payment server 103 can facilitate payment from the proxy shopper to the merchant for the product purchased. The same payment server 103, or a different payment server 103, can facilitate payment from the user to the proxy shopper. The payment server 103 can belong to a payment provider, such as Paypal, Inc.

The payment server 103 can have a processor 105 in communication with a database 106. The processor 105 can access a user account 107 and a proxy shopper account 108. Information regarding the user account 107 and the proxy shopper account 108 can be stored in the database 106 or can be stored anywhere else. Information regarding the user account 107 and the proxy shopper account 108 can be stored in the same place as each other or can be stored in different places with respect to each other, e.g., in different databases. The user account 107 and the proxy shopper account 108 can be with the same card company or payment provider or can be with different card companies or payment providers.

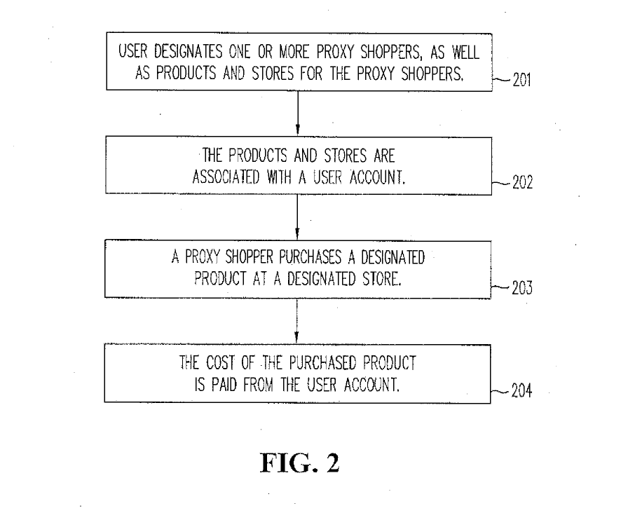

The merchant checkout system 102 can communicate with the payment server 103, such as via a network. For example, the merchant checkout system 102 can communicate with the payment server 103 via the Internet 104. The merchant checkout system 102 can communicate with a plurality of different the payment servers 103. The plurality of different payment servers 103 can communicate among themselves and can be considered the same as a single payment server 103 herein. FIG. 2 is a flow chart showing a method for making adaptive payments, according to an embodiment. A user can designate one or more proxy shoppers, as well as products and stores for the proxy shoppers, as shown in step 201. The same products and stores can be designated for each proxy shopper. Alternatively, different products and stores can be designated for each proxy shopper. Any combination of the same and different products and stores can be designated for the proxy shoppers. For example, all of the proxy shoppers can be required to use the same stores, but can have different designated products. As a further example, all of the proxy shoppers can have the same designated products, but can be required to use different stores.

A proxy shopper can be a friend or relative of the user. A proxy shopper can be an employee of the user, A proxy shopper can be a professional proxy shopper. The proxy shoppers can have any desired relationship with respect to the user. The user can designate any desired number of proxy shoppers. For example, a parent can designate several adult children as proxy shoppers.

The user can designate proxy shoppers via a web site, such as a web site of the payment provider. The user can designate proxy shoppers by filing out a form. The form can be either a paper form or a form on the web site. The user can designate proxy shoppers over the telephone, such as in a telephone conversation with a representative of the payment provider.

The proxy shopper can be designated by a particular account of the proxy shopper, e.g., the proxy shopper account 108. For example, the proxy shopper can be designated by a Paypal account number. Thus, when a designated product is purchased at a designated store by the proxy shopper, then payment for the purchase can be automatically made from the Paypal account of the user to a Paypal account of the proxy shopper, for example.

The user can be given an opportunity to review purchases made by the proxy shopper and can be allowed to individually authorize or not authorize payment for each purchase. The user can review the purchases substantially in real time, e.g., as the purchases are being made. The user can review the purchases after the purchases have been made.

Thus, the user can designate what stores the proxy shopper can use to shop for the user. The stores can be designated as individual stores (such as at specified locations), as chains (such as all of the stores of a particular franchise), or in any other manner. Specific stores can be designated by their address. For example, the Vons at 1135 Harbor Blvd., Costa Mesa can be designated. The stores can be selected from a map, such as a map presented by a web site. The map can be presented by the payment provider or by a third party.

The stores can be designated by type or location. The stores can be designated generically. For example, all of the convenience stores in the city of Irvine, Calif. can be designated as such, rather than by designating the stores individually. As a further example, all of the Vons supermarkets can be designated, regardless of location.

Geographic boundaries can be specified for the proxy shopper. The geographic boundaries can be selected from a map, such as a map presented by a web site. The map can be presented by the payment provider or by a third party. The geographic boundaries can be selected by defining lines on the map. The geographic boundaries can be selected by using existing boundaries, e.g., city limits, roads, railroad tracks, rivers, etc. Only stores within the geographic boundaries can be used by the proxy shopper on behalf of the user.

The products can be designated very generally. For example, food, toiletries, and clothing can be designated. In this instance, the proxy shopper can purchase any food, toiletries, and clothing at a designated stored.

The products can be designated somewhat generally. For example, canned vegetables, canned soups, and frozen dinners can be designated. In this instance, the proxy shopper can purchase any canned vegetables, canned soups, and frozen dinners, regardless of size or brand, as long as the products are purchase at a designated store. The products can be designated specifically. For example, the designations can include Campbell's Chicken Noodle Soup, ten ounce size; Bumble Bee Chunk Light Tuna, 3 pack; and boxes of Quaker Instant Oatmeal having 8 twelve ounce packets. In this instance, only Campbell's Chicken Noodle Soup, ten ounce size; Bumble Bee Chunk Light Tuna, 3 pack; and Quaker Instant Oatmeal boxes having 8 twelve ounce packets can be purchase and these products must be purchased at a designated store.

The products can be designated by stock keeping unit (SKU) or bar code. The products can be designated by any code or number that can be used to designate such products.

A limited quantity of each product to be purchased can be specified. The limit can be in units (cans or boxes, for example), weight, or in any other manner. The limit can be for a specified time period. For example, the proxy shopper can be allowed to purchase up to 10 cans of Campbell's Chicken Noodle Soup, in the ten ounce size in a calendar month.

Price limits can be set. Price limits can be set for total purchases by a given proxy shopper in a specified time. For example, a given proxy shopper can be limited to making $500 in purchases within any calendar month. Price limits for products can be set. For example, the proxy shopper can be limited to purchasing $50 worth of toiletries in any calendar month. Each proxy shopper can have individual price limits. A common set of price limits can apply to all proxy shopper for a given user.

All stores and only specified products can be designated. Thus, the proxy shopper can shop at any store as long as the proxy shopper only purchases the specified products for the user. All products and only specified stores can be designated. Thus, the proxy shopper can purchase any products for the user as long as the proxy shopper purchases the products at the specified stores.

The products and stores designated for the proxy shoppers can be associated with the user account 107, as shown in step 202. Information regarding the products and stores designated for the proxy shoppers and associated with the user account 107 can be stored, such as in database 106.

Thus, the proxy shopper can purchase designated products at a designated store as shown in step 203. The proxy shopper can, during the same checkout procedure, purchase other products, e.g., non-designated products (such as for use by the proxy shopper rather than for use by the user). The proxy shopper will typically only be reimbursed for the designated products. However, the user can be given an opportunity to pay for any of the products purchased.

The proxy shopper can purchase products for different users. Each product can be paid for, e.g., by reimbursing the proxy shopper, by the particular user that designated that product. When a product is designated by more that one user, the proxy shopper can specify which user is to pay for the product. For example, the proxy shopper can specify which user is to pay for the product by accessing a web site of the payment provider. This can be done at the time of purchase or after the purchase is made. The user can specify which user is to pay for the product at the time of purchase via the merchant terminal.

The cost of the purchased products can be paid from the user account 107 to the proxy shopper account 108, as shown in step 204. This reimbursement can be completely automatic and invisible to the proxy shopper. Thus, the proxy shopper's account statement can omit any reference to such purchases. Alternatively, the proxy shopper's account statement can list such purchases and can show such purchases as reimbursed or paid for by the user.

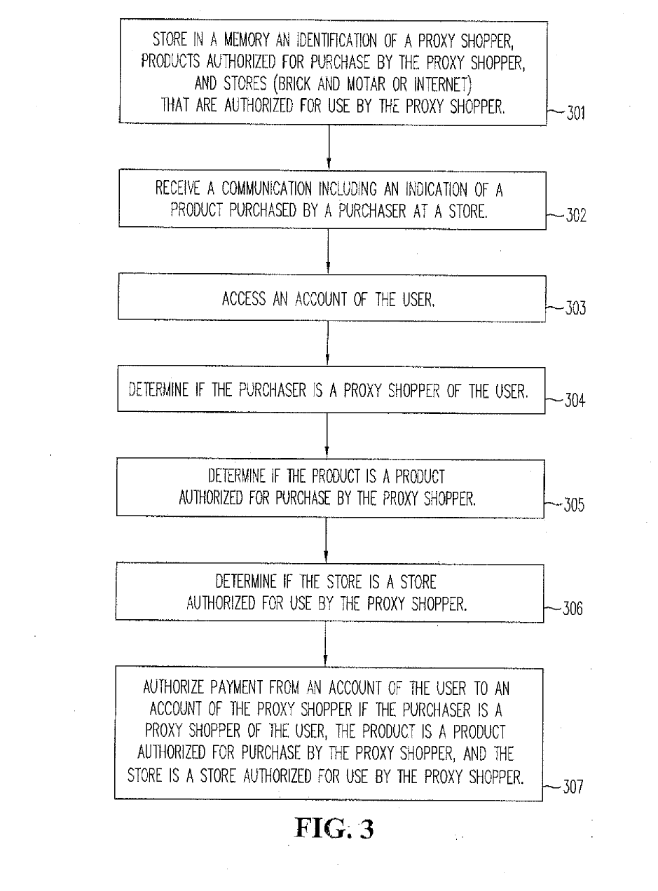

FIG. 3 is a flow chart showing the method for making adaptive payments in further detail, according to an embodiment. An identification of a proxy shopper, products authorized for purchase by the proxy shopper, and stores authorized for user by the proxy shopper can be stored in a memory such as database 106, as shown in step 301. A communication can be received by the processor 105 that includes an indication of a product purchased by a purchaser at a store 101, as shown in step 302. The purchaser may be a proxy shopper or may not be a proxy shopper.

The identification of the proxy shopper can include account information of the proxy shopper. For example, the identification of the proxy shopper can include an account number of the proxy shopper. The account number can be a bank account number, a card account number, a payment provider account number, or any other type of account number.

The communication can be sent from a bank, payment provider, or other financial institution of the proxy shopper to the processor 105 in response to the purchase by the proxy shopper. The communication can be sent from the merchant checkout system 102 of the store 101 to the processor 105 in response to the purchase by the proxy shopper.

The proxy shopper and the user can share the same bank, payment provider, or other financial institution or can have different banks, payment providers, or other financial institutions. The bank, payment provider, or other financial institution can administer the accounts of the user and proxy shopper.

The processor 105 can access the user account 107, as shown in step 303. The processor 105 can determine from the user account 107 if the purchaser is a proxy shopper of the user, as shown in step 304. The processor 105 can determine from the user account 107 if the product is a product authorized for purchase by the proxy shopper, as shown in step 305. The processor 105 can determine from the user account 107 if the store is a store authorized for use by the proxy shopper, as shown in step 306.

The processor 105 can authorize payment from the user account 107 if the purchaser is a proxy shopper of the user, the product is a product authorized for purchase by the proxy shopper, and the store is a store authorized for use by the proxy shopper, as shown in step 307. The processor 105 can authorize payment from the user account 107 to the proxy shopper account 108. The processor 105 can authorize payment for the products purchase by the proxy shopper for the user in any desired manner.

If the purchaser is a proxy shopper of the user, but the product is not a product authorized for purchase by the proxy shopper or the store is not a store authorized for use by the proxy shopper, then the processor 105 can optionally notify the user and ask the user if the processor 105 can authorize a payment by the user for the products purchased. The user can determine whether or not to receive such notification, such as during a setup process for the proxy shopper.

Thus, the proxy shopper can be reimbursed for the purchase. Alternatively, the cost of the purchased product can be paid directly by the user without first charging the purchase to the proxy user. For example, the cost of the purchase for an authorized product can be charged directly to the user account 107, even though the purchase is being made with a card of the proxy shopper. When the cost of the purchased product is paid directly by the user, then the proxy shopper is not reimbursed since the proxy shopper was not charged for the purchase. Whether the proxy shopper is reimbursed for the purchase or the purchased product is paid for directly by the user, the effect can be as if the user, rather than the proxy shopper, made the purchase.

Indeed, for many intents and purposes, it can appear as if the user made the purchase in person. Thus, the user's payment provider statement and the proxy shopper's payment provider statement, for example, can reflect the purchase as being made by the user, without any involvement of the proxy shopper.

According to embodiments, purchases can be made by the proxy shopper for the user either in brick and mortar stores or online stores. Purchases can be made by the proxy shopper for the user in any desired manner. For example, such purchases can be made at swap meets, from mobile vendors, or from any other merchants. The purchases can be made for goods or services. For example, a purchase can be for automobile repairs.

The term “product” as used herein can refer to goods or services. The term “product” as used herein can refer to anything that can be purchased.

The term “card” as used herein can include credit cards, debit cards, gift cards, and the like. The term “card” as used herein can include electronic devices used to make purchases. For example, the term card can include transponders, cellular telephones, and other mobile devices. The term card can include any device used to facilitate a purchase. The term “card” as use herein can refer to a payment provider account.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

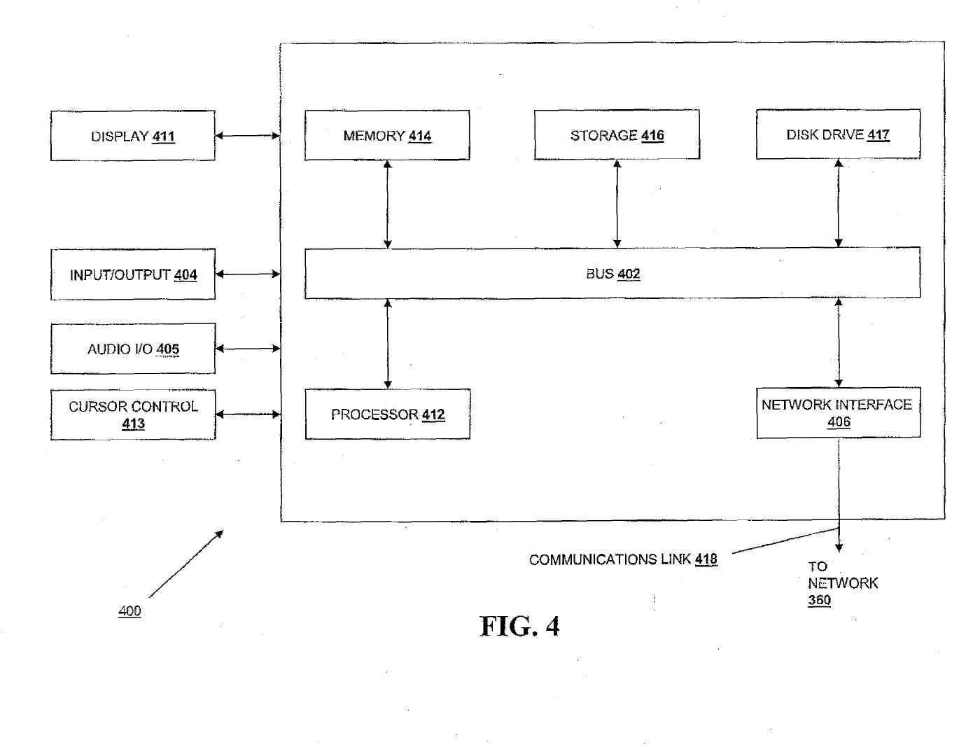

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation. Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a memory storing account information for a user, the account information including an identification of a proxy shopper, a product authorized for purchase by the proxy shopper, and a store authorized for use by the proxy shopper;
a processor operable to:
receive a communication including an indication of a purchase by a purchaser;
access the account information;
determine from the account information if the purchaser is the proxy shopper;
determine from the account information if the purchase is for the product authorized for purchase by the proxy shopper;
determine from the account information if the purchase is from the store authorized for use by the proxy shopper; and
authorize payment from a user account to a proxy shopper account if the purchaser is the proxy shopper, the purchase is for the product authorized for purchase by the proxy shopper, and the purchase is from the store authorized for use by the proxy shopper.

2. The system of claim 1, wherein the memory is a memory of a payment server.

3. The system of claim 1, wherein the processor is a processor of a payment server.

4. The system of claim 1, wherein the identification of the proxy shopper includes account information of the proxy shopper.

5. The system of claim 1, wherein the identification of the proxy shopper includes payment provider account information of the proxy shopper.

6. The system of claim 1, wherein the user account is a payment provider account.

7. The system of claim 1, wherein the user account is a bank account.

8. A method comprising:
storing, in a memory, account information for a user, the account information including an identification of a proxy shopper, a product authorized for purchase by the proxy shopper, and a store authorized for use by the proxy shopper;
receiving, electronically by a processor, a communication including an indication of a purchase by a purchaser;
accessing, by the processor, the account information;
determining from the account information, by the processor, if the purchaser is the proxy shopper;
determining from the account information, by the processor, if the purchase is for the product authorized for purchase by the proxy shopper;
determining from the account information, by the processor, if the purchase is from the store authorized for use by the proxy shopper; and
authorizing, by the processor, payment from a user account to a proxy shopper account if the purchaser is the proxy shopper, the purchase is for the product authorized for purchase by the proxy shopper, and the purchase is from the store authorized for use by the proxy shopper.

9. The method of claim 8, wherein the memory is a memory of a payment server.

10. The method of claim 8, wherein the processor is a processor of a payment server.

11. The method of claim 8, wherein the identification of the proxy shopper includes account information of the proxy shopper.

12. The method of claim 8, wherein the identification of the proxy shopper includes payment provider account information of the proxy shopper.

13. The method of claim 8, wherein the account of the user is a payment provider account.

14. The method of claim 8, wherein the account of the user is a bank account.

15. A computer program product comprising a non-transitory computer readable medium having computer readable and executable code for instructing a processor to perform a method, the method comprising:
storing, in a memory, account information for a user, the account information including an identification of a proxy shopper, a product authorized for purchase by the proxy shopper, and a store authorized for use by the proxy shopper;
receiving, electronically by a processor, a communication including an indication of a purchase by a purchaser;
accessing, by the processor, the account information;
determining from the account information, by the processor, if the purchaser is the proxy shopper;
determining from the account information, by the processor, if the purchase is for the product authorized for purchase by the proxy shopper;
determining from the account information, by the processor, if the purchase is from the store authorized for use by the proxy shopper; and
authorizing, by the processor, payment from a user account to a proxy shopper account if the purchaser is the proxy shopper, the purchase is for the product authorized for purchase by the proxy shopper, and the purchase is from the store authorized for use by the proxy shopper.

16. The method of claim 15, wherein the memory is a memory of a payment server.

17. The method of claim 15, wherein the processor is a processor of a payment server.

18. The method of claim 15, wherein the identification of the proxy shopper includes account information of the proxy shopper.

19. The method of claim 15, wherein the identification of the proxy shopper includes payment provider account information of the proxy shopper.

20. The method of claim 15, wherein the account of the user is a payment provider account.

21. The method of claim 15, wherein the account of the user is a bank account.
